(19) United States
(12) Patent Application Publication
(10) Pub. No.: US 2012/0326451 A1
(43) Pub. Date: Dec. 27, 2012

(54) SYSTEM FOR UTILIZING THE ENERGY OF ELECTRICAL STORM DISCHARGES

(76) Inventor: Gaston Giraldo Olivares, Bogota (CO)

(21) Appl. No.: 13/476,771

(22) Filed: May 21, 2012

(30) Foreign Application Priority Data
May 20, 2011 (CO) 11-062640

(51) Int. Cl. F03G 3/00

(52) U.S. Cl. 290/1 R

(57) ABSTRACT

The present invention consisting of the following system built from a lightning rod or a group of them in a field or area to capture the electric discharge or discharges during a storm, these lightning rods connected to a central system of a solenoid or electromagnet, which at the moment of receiving the discharge through the rod generates an electromagnetic force of attraction, wherein the solenoid is disposed in a road or lane on which a series of aligned rolls or metallic cylinders due to the magnetic attraction of the electromagnet move by said track in an upwardly by the slope and once above by the effect of gravity, descend through the same channel dragging a conveyor belt by like a transmission chain that engages with the teeth of a gear whose rotation moves in turn electricity generator that is transformed and distributed for its consumption.

The present application claims international priority of Colombia's patent application serial No. 11-062640 filed on May 20, 2011.

### BACKGROUND OF THE INVENTION

1. Field of the Invention

The present invention relates to the field of electricity generation.

2. Description of the Related Art

The era of oil use seems to be approaching its end by the increasing rise of other forms of cleaner, more effective, economic, and les contaminant alternative energy sources, that currently are not yet enjoying full use.

About the statement that energy is not created nor destroyed but transformed, we have developed this project of invention, not yet known until now, which seeks to transform the energy of the electric discharges or lightning so far been regarded as lethal and destructive into other type of energy smart and of controlled use.

Indeed, lightning or electrical discharges are seen as a destructive phenomenon, for which there have been invented devices for protection such as lightning rods for personal, community and industrial protection.

The invention proposes a system or assembly of elements that take advantage of the electrical discharge to generate energy in a controlled and accumulative way for regulated consumption.

### SUMMARY OF THE INVENTION gravitational potential energy to be subsequently released to mechanically actuate electricity generators.

It is another object of the present invention to protect the areas surrounding the system's installation with the lightening rod assembly.

Further objects of the invention will be brought out in the following part of the specification, wherein detailed description is for the purpose of fully disclosing the invention without placing limitations thereon.

### BRIEF DESCRIPTION OF THE DRAWINGS

FIG. 1 shows in a schematic form the assembly of the elements for the proposed system.

FIG. 2 represents the top or plant view of the assembly shown in the previous figure.

### DETAILED DESCRIPTION OF THE EMBODIMENTS OF THE INVENTION

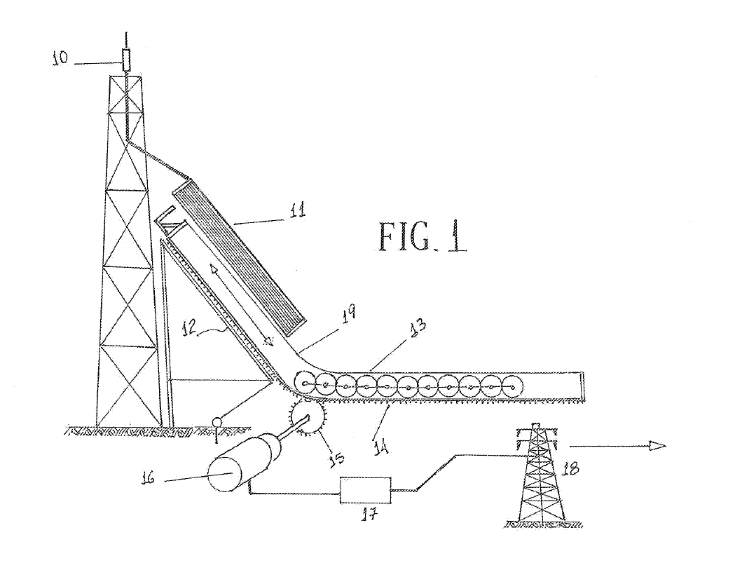

According to what is illustrated in FIG. 1, the invention prevents the provision of one or more lightning rods (10) arranged in a broad strip of and to capture the electric discharges generated during a storm, casual or induced.

The discharge captured by the rod is passed through a connection of the rod to a solenoid (11) like an electromagnet with its corresponding winding, which in turn will produce a great magnetic attraction force around it. Parallel to said electromagnet (11) there is an assembly or track-like structure (12) in a non-magnetic material, simulating a path on a slope of about 45 degrees upward (roller coaster type) and its placed over said lane a group of rolls or cylinders (13), metallic, solid made of magnetic material, linked together with each other arranged to roll on the rails (20) of the runway through external bearings (21) in each roll, rolling that is made through the rolls without falling off the track.

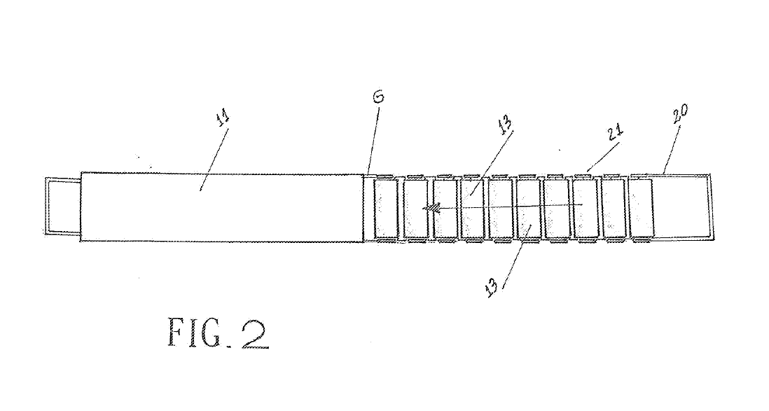

When the electrical discharge takes place an electromagnetic force is produced for a few seconds of duration, time in which the rolls (13) are attracted by the solenoid, causing the rolls to move across the tracks ascending the mentioned slope (FIG. 2) until a certain height determined in proportion to the intensity of each electrical discharge.

Once above the rolls or cylinders tend by gravity to descend the runway, and on its descent they activate or drag a band or tape (14) that like a transmission chain drives the toothed gearing (15), one that in turn drags in its rotation the shaft of a turbine or generator (16) of electricity, with what it is achieved the purpose of the invention, as is taking advantage of the generation of electricity with the use of a bolt or electrical discharge, by then, after passing through the area of transformers (17) is carried by (18) to consumption.

In the event that an electrical discharge is of such magnitude that exceeds the capacity of the system and all the rolls (13) are raised to the stated top, unable to go any higher, the system has in its conception an electrical contact to transfer the electric shock to a second assembly parallel to said system to produce a magnetic field that produces the same effects on the rolls or cylinders, raising and lowering.

In this sense we can have a group of structures or systems as described, assembled in parallel over an area or and field subject to a permanent electrical discharges. Additionally, it can be attempted to get a series of electrical discharges in the same location of the installation to keep the system operating optimally and regularly.

In a variant to the herein stated, the rolls or cylinders (13) can be maintained at a certain height to store the potential energy they have in descent work.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A system to take advantage of the energy of the electrical discharges or lightning bolts in order to concentrate the energy in an element generator of electromagnetic force, capable to move by attraction and in a upwardly form some rolling metallic elements to a certain height, ones that while descending by the gravitational action actuate a belt or gear transmission element as a power generator, said system characterized by an assembly or construction comprising of the following:
A) one or more lightning rods (10) electrical discharge receivers;
B) an electromagnet (11) or solenoid connected to the lightning rods or rods;
C) a support structure (12) of a nonmagnetic metallic material, which supports a transportation runway (20);
D) rollers or cylinders (13) of magnetic metallic material, linked together with each rolling bearings (21) at their endpoints;
E) a band/tape (14) or chain connected to the rolls or metal cylinders; and
F) a power generation system connected to the belt conveyor (14) by a toothed wheel or gear (15).

2. The system according to claim 1 wherein the solenoid (11) energized by the electrical discharge produces an electromagnetic field to attract the rolls (13) in an upward displacement thereof to a certain point, ones in which in its gravitational descent will drag tape or chain (14) engaging on to a toothed wheel or gear (15) in turn connected to a generator or turbine (16) producing electrical energy.

3. The system according to claim 2, further characterized by the adaptation of an electrical contact that sends to a similar system assembled in parallel to handle the power excess caused by an electric discharge of great magnitude.

4. The system set forth in claim 3 wherein said lightening rods are connected in groups in an area.

5. A system for utilizing the energy produced by electrical storms comprising:
A) a lighting rod assembly for attracting electrical storm discharges;
B) an inductive assembly having first and second contacts, said first contact being electrically converted to said lightering rod assembly and said second contact being electrically connected to a ground; so that a magnetic field is generated when a voltage differential is applied between said lightening rod and said ground.
C) at least one ferromagnetic mass slidably mounted over a rail assembly, said mass being movable between a first position and a second higher position, said mass magnetically coacting with said magnetic field to temporarily lift said mass from said first position towards said second position thereby increasing its gravitational potential energy; and dropping to said first position upon the disappearing of said magnet field so that the potential energy is released and brought back to said first position;
D) generator means for converting the change in gravitational energy imparted to said mass into electricity.
